(19) United States
(12) Patent Application Publication
(10) Pub. No.: US 2013/0183620 A1
(43) Pub. Date: Jul. 18, 2013

(54) CHEMICAL COATING COMPOSITION FOR FORMING A LASER-MARKABLE MATERIAL AND A LASER-MARKABLE MATERIAL

(71) Applicants: Yuka Ogo, Pearl River, NY (US); Richard Whitehouse, Hamilton, NJ (US); Kazuaki Yoshida, Allendale, NJ (US)

(72) Inventors: Yuka Ogo, Pearl River, NY (US); Richard Whitehouse, Hamilton, NJ (US); Kazuaki Yoshida, Allendale, NJ (US)

(21) Appl. No.: 13/353,095

(22) Filed: Jan. 18, 2012

(51) Int. Cl. G03C 1/73

(52) U.S. Cl. 430/138

(57) ABSTRACT

Disclosed is a chemical coating composition for recording an image on a recording material that forms a color image by irradiation with a laser beam. Further, the chemical coating composition comprises at least one microcapsule encapsulating a basic dye precursor, and at least one plastic dispersion. Also disclosed is a recording material using the inventive chemical coating composition, as well as a recording method using the chemical coating composition dried onto a recording material which is then subsequently irradiated with a laser.

### FIELD OF THE INVENTION

The present invention relates to a chemical coating composition, an image recording material using the chemical coating composition, and an image recording method using the chemical coating composition. More particularly, the present invention relates to a chemical coating composition for recording an image on a recording material that forms a color by irradiation with a laser beam.

### BACKGROUND OF THE INVENTION

On beverage cans, beverage containers, food containers, medicine containers, cosmetics containers, packaging materials, electronic components, electric parts, automotive components and the like (hereinafter referred to as “containers”), a manufacturing lot number, manufacturing date, model, name of manufacturer, and the like are, for example, marked by characters, symbols, marks, patterns, barcodes or the like (hereinafter referred to as “marks”).

As one type of marking method, a method of directly printing a colored printing ink on containers by pad printing, screen printing, an ink jet method or the like, and a method of attaching labels having marks printed thereon are used. In the direct printing method, however, printing may be difficult depending on the shape of the container to be printed on, and in the method of attaching printed labels, a wide variety of labels must be prepared for respective types of marks.

To solve these problems, recently laser marking methods have come to be used in which a laser marking layer (hereinafter referred to as “layer”). comprising a color former and a developer, is provided on containers, and a laser beam is irradiated on the layer to cause a chemical reaction to form a color (see, for example, Japanese Patent Application Laid-Open (JP-A) No. 2007-152686). This method is superior in productivity to the previous methods and thus is suitable for forming marks on containers.

In the laser marking method, however, when a laser is irradiated to form a mark, a mark with sufficient optical density may not be obtained or when a chemical coating composition (hereinafter referred to as “coating composition”) including a color former and a developer is stored for several months, a coating composition may not be usable and effective due to increased solution viscosity. As a result, the current laser marking methods are not acceptable for commercial use.

### SUMMARY OF THE INVENTION

Embodiments of the present invention have been made in view of the above circumstances and provides a coating, a recording material, and a recording method that overcome the disadvantages of the prior art.

According to one aspect of embodiments of the invention, there is provided a chemical coating composition for a recording material that forms a color image by irradiation with a laser beam, comprising at least one microcapsule encapsulating a basic dye precursor, and at least one plastic dispersion. Another aspect is a recording material using the coating composition, as well as a recording method using the coating composition dried onto a recording material which is then subsequently irradiated with a laser.

### DETAILED DESCRIPTION OF THE PRESENT INVENTION

(1) A coating composition for a recording material to record an image by irradiation with a laser beam, comprising at least one microcapsules encapsulating a basic dye precursor, and at least one plastic dispersion.

(2) The coating composition according to (1), wherein the plastic dispersion comprises at least one plastic wax dispersion.

(3) The coating composition according to (1) and/or (2), wherein the plastic dispersion comprises at least one polyethylene wax dispersion.

(4) The coating composition according to (1), (2) and/or (3), wherein the plastic dispersion comprises at least one dispersion of combination of polyethylene wax and polytetrafluoroethylene.

(5) The coating composition according to (1), (2), (3) and/or (4), comprising at least one polyvinyl alcohol containing a carboxylic substituent.

(6) The recording material and the recording method to record an image by irradiation of a laser beam, comprising a recording layer on a support, wherein the recording layer comprises at least one microcapsules encapsulating a basic dye precursor, and at least one the plastic dispersion.

(7) The recording material and the recording method according to claim (6), wherein the recording layer comprises at least one coating composition according to claim (2), (3), (4) and/or (5).

(8) The recording material and the recording method according to claim (6) and/or (7), the recording material has no protective layer onto the recording layer.

(9) The recording material and the recording method according to claim (6), (7) and/or (9), wherein the support comprises at least one corrugated fiberboard layer for the outer case.

Embodiments of the present invention are based on the following new findings.
1) One or more plastic dispersions incorporated into a chemical coating composition can significantly increase optical density of a mark formed by laser irradiation.
2) Removal of a protective layer coated on the recording layer can significantly increase optical density of the mark formed by the laser irradiation.
3) The support of a corrugated fiberboard for outer case can increase lay-down of the coating composition and increase the optical density of the mark formed by the laser irradiation.
4) Addition of at least one plastic dispersion to the coating composition can significantly reduce formation of unfavorable pressure marks by scratching without the use of a protective layer coated onto the recording layer.
5) At least one polyvinyl alcohol compound which contains at least one carboxylic substituent group, when incorporated into the chemical coating composition, can stabilize the viscosity of the chemical coating composition during long term storage.

### <Chemical Coating Composition>

The chemical coating composition used to make the recording material that is used in the recording method of the present invention contains at least one color-forming component and at least one plastic dispersion and may further contain other components as needed.

### (Plastic Dispersion)

The plastic dispersion of the present invention is preferably a plastic wax dispersion, more preferably a polyethylene wax dispersion. Dispersion of a combination of polyethylene wax and polytetrafluoroethylene is the most preferred. The quantity of the plastic dispersion in the chemical coating composition is from about 0.1% w/w to about 20% w/w, preferably from about 1% w/w to about 10% w/w.

### (Color-Forming Component)

The color-forming component may be a component that has good transparency before laser exposure but quickly forms an image by laser exposure. Examples of the color-forming component include a two-component type color-forming components, which contains a substantially colorless color-forming component A and a substantially colorless color-forming component B that reacts with the color-forming component A to form an image. In one or more embodiments of the invention, a combination of a basic dye precursor and an electron-accepting compound is used, wherein the basic dye precursor is encapsulated in microcapsules.

The basic dye precursor which is used in the invention may be any basic dye precursor that is substantially colorless, but not limited thereto. The precursor may have a nature of donating an electron to form a color, or accepting a proton from an acid to form a color, and is preferably a colorless compound having a partial skeleton of lactone, lactam, sultone, spiropyran, ester, amide or the like, the skeleton being opened or cleaved when the compound contacts with an electron-accepting compound.

Examples of the basic dye precursor include triphenylmethanephthalide compounds, fluorane compounds, phenothiazine compounds, indolylphthalide compounds, leuco auramine compounds, rohdamine lactam compounds, triphenylmethane compounds, triazene compounds, spiropyran compounds, fluorene compounds, pyridine compounds and pyrazine compounds.

Specific examples of the triphenylmethanephthalide compounds include compounds described in U.S. Reissued Pat. No. 23,024, and U.S. Pat. Nos. 3,491,111, 3,491,112, 3,491,116, and 3,509,174, the disclosures of which are incorporated by reference herein.

Specific examples of the fluorane compounds include compounds described in U.S. Pat. Nos. 3,624,107, 3,627,787, 3,641,011, 3,462,828, 3,681,390, 3,920,510, and 3,959,571, the disclosures of which are incorporated by reference herein.

Specific examples of the spiropyran compounds include compounds described in U.S. Pat. No. 3,971,808, the disclosures of which are incorporated by reference herein.

Specific examples of the pyridine compounds and the pyrazine compounds include compounds described in U.S. Pat. Nos. 3,775,424, 3,853,869 and 4,246,318, the disclosures of which are incorporated by reference herein.

Specific examples of the fluorene compounds include compounds described in JP-A No 63-094878, the disclosure of which is incorporated by reference herein.

Among these compounds, a particularly preferable example is 2-arylamino-3-[H, halogen, alkyl or alkoxy-6-substituted aminofluorane], which forms a black color.

Specific examples thereof include 2-anilino-3-methyl-6-diethylaminofluorane, 2-anilino-3-methyl-6-N-cyclohexyl-N-methylaminofluorane, 2-p-chloroanilino-3-methyl-6-dibutyl amino fluorane, 2-anilino-3-methyl-6-dioctylaminofluorane, 2-anilino-3-chloro-6-diethylaminofluorane, 2-anilino-3-methyl-6-N-ethyl-N-isoamylaminofluorane, 2-anilino-3-methyl-6-N-ethyl-N-dodecylaminofluorane, 2-anilino-3-methoxy-6-dibutylaminofluorane, 2-O— chloroanilino-6-dibutylaminofluorane, 2-p-chloroanilino-3-ethyl-6-N-ethyl-N-isoamylaminofluorane, 2-o-chloroanilino-6-p-butylanilinofluorane, 2-anilino-3-pentadecyl-6-diethylaminofluorane, 2-anilino-3-ethyl-6-dibutylaminofluorane, 2-o-toluidino-3-methyl-6-diisopropylaminofluorane, 2-anilino-3-methyl-6-N-isobutyl-N-ethylaminofluorane, 2-anilino-3-methyl-6-N-ethyl-N-tetrahydrofurfurylaminofluorane, 2-anilino-3-chloro-6-N-ethyl-N-isoamylaminofluorane, 2-anilino-3-methyl-6-N-methyl-N-[gamma]-ethoxypropylaminofluorane, 2-anilino-3-methyl-6-N-ethyl-N-[gamma]-ethoxypropylaminofluorane, and 2-anilino-3-methyl-6-N-ethyl-N-[gamma]-propoxypropylaminofluorane.

More specific examples thereof include bisphenol compounds such as 2,2-bis(4′-hydroxyphenyl)propane [common name: bisphenol A], 2,2-bis(4′-hydroxyphenyl)pentane, 2,2-bis(4′-hydroxy-3′,5′-dichlorophenyl)propane, 1,1-bis(4′-hydroxyphenyl)cyclohexane, 2,2-bis(4′-hydroxyphenyl)hexane, 1,1-bis(4′-hydroxyphenyl)propane, 1,1-bis(4′-hydroxyphenyl)butane, 1,1-bis(4′-hydroxyphenyl)pentane, 1,1-bis(4′-hydroxyphenyl)hexane, 1,1-bis(4′-hydroxyphenyl)heptane, 1,1-bis(4′-hydroxyphenyl)octane, 1,1-bis(4′-hydroxyphenyl)-2-methyl-pentane, 1,1-bis(4′-hydroxyphenyl)-2-ethyl-hexane, 1,1-bis(4′-hydroxyphenyl)dodecane, 1,4-bis(p-hydroxyphenylcumyl)benzene, 1,3-bis(p-hydroxyphenylcumyl)benzene, bis(p-hydroxyphenyl)sulfone, bis(3-allyl-4-hydroxyphenyl)sulfone, and bis(p-hydroxyphenyl)benzyl acetate ester;

salicylic acid derivatives such as 3,5-di-[alpha]-methylbenzylsalicylic acid, 3,5-di-tert-butylsalicylic acid, −3[alpha]-[alpha]-dimethylbenzylsalicylic acid, and 4-([beta]-p-methoxyphenoxyethoxy)salicylic acid;

polyvalent metal salts of the salicylic acid derivatives (preferably, zinc and aluminum salts of the salicylic acid derivatives);

oxybenzoic acid esters such as benzyl p-hydroxybenzoate, 2-ethylhexyl p-hydroxybenzoate, and [beta]-resorcylic acid-(2-phenoxyethyl)ester; and

phenols such as p-phenylphenol, 3,5-diphenylphenol, cumylphenol, 4-hydroxy-4′-isopropoxy-diphenylsulfone, and 4-hydroxy-4′-phenoxy-diphenylsulfone.

The bisphenol compounds are particularly preferable since they give a satisfactory color forming property. A single electron-accepting compound may be used or multiple electron-accepting compounds may be simultaneously used.

### (Microcapsules)

The process for producing the microcapsule will be described in detail hereinafter.

The interfacial polymerization method, the internal polymerization method, and the external polymerization method are known as methods for producing microcapsules. Any one thereof may be employed.

As described above, the coating composition of this invention contains microcapsules encapsulating a basic dye precursor. It is particularly preferable to employ the interfacial polymerization method which comprises the step of mixing an oil phase prepared by dissolving or dispersing the basic dye precursor, which will be the core of the capsules, in a hydrophobic organic solvent with a water phase comprising a dissolved water-soluble polymer, the step of emulsifying the mixture by means of a homogenizer or the like, and the step of heating the emulsion to cause a polymer forming reaction at the interface between the oil droplets and water, thereby forming microcapsule walls made of a polymer material.

The wall materials for making the polymer material are added to the inside and/or the outside of the oil droplets. Specific examples of the polymer material include polyurethane, polyurea, polyamide, polyester, polycarbonate, urea-formaldehyde resin, melamine resin, polystyrene, and styrene-methacrylate copolymer, styrene-acrylate copolymer. Among these polymers, polyurethane, polyurea, polyamide, polyester, and polycarbonate are preferable. Polyurethane and polyurea are more preferable.

For example, if polyurea is used for the material of the capsule walls, the microcapsule walls can easily be formed by allowing a polyisocyanate such as a diisocyanate, triisocyanate, tetraisocyanate or polyisocyanate prepolymer to react with a polyamine such as a diamine, triamine or tetraamine, a prepolymer having 2 or more amino groups, piperazine or a derivative thereof, or a polyol in the above-mentioned water phase by the interfacial polymerization method.

For example, composite walls composed of polyurea and polyamide, or composite walls composed of polyurethane and polyamide can be prepared by incorporating polyisocyanate and a second material which reacts with the polyisocyanate to form capsule walls (for example, acid chloride, polyamine or polyol) into an aqueous solution (water phase) of a water-soluble polymer or an oil medium (oil phase) to be encapsulated, emulsifying the mixture, and heating the resultant emulsion. Details of this method of producing the composite walls made of polyurea and polyamide are described in JP-A No. 58-66948, the disclosure of which is incorporated by reference herein.

In one or more embodiments of the invention, the capsule wall material preferably contains at least one isophorone diisocyanate compound. By forming the microcapsule by using a wall material containing an isophorone diisocyanate compound, the capsule wall is made hydrophobic, water adsorption at high humidity is decreased, and water desorption at low humidity is decreased, whereby the ambient humidity dependence of the thermal response of the microcapsule is decreased. As a result, the ambient humidity dependence of the sensitivity of the recording material is decreased.

As mentioned above, the capsule wall material preferably contains at least one isophorone diisocyanate compound. The wall material preferably contains an isophorone diisocyanate compound as a main component (the content in the wall material being 50% by mass or more), and the content of a material derived from isophorone diisocyanate is preferably 50% by mass or more. The isophorone diisocyanate compound may be either monomer or multimer of isophorone diisocyanate, and trimer is particularly preferred. A mixture of dimer and trimer of isophorone diisocyanate is also preferably used as a wall material, and the rate of trimer is preferably 20% by mass or more and more preferably 50% by mass or more in the total weight of the capsule wall material.

In a range not impeding the effect of decreasing the ambient humidity dependence of the sensitivity of the recording material, in addition to the isophorone diisocyanate compound, other monomers or prepolymers may be used, whereby various highly hydrophobic microcapsules may be formed. It is preferable that, as the other monomers or prepolymers, a polyamine, a prepolymer having two or more amino groups, piperazine or its derivative, or a polyol may be used in combination with the above-mentioned isophorone diisocyanate monomer and/or multimer to form microcapsules of a polyurea or polyurethane.

In a range not impeding the effect of decreasing the ambient humidity dependence of the sensitivity of the recording material, in addition to the isophorone diisocyanate compound, other polyisocyanate compounds may be used. Other polyisocyanate compounds are preferably compounds having three or more isocyanate groups. However, a compound having three or more isocyanate group may be used in combination with a compound having two isocyanate groups, or a compound having two isocyanate groups may be used alone. Specific examples include xylene diisocyanate and a hydrate thereof, hexamethylene diisocyanate, trilene diisocyanate and a hydrate thereof; a dimer or trimer (biuret or isocyanurate) of a diisocyanate such as isophorone diisocyanate; a multifunctional adduct of a polyol such as trimethylol propane and a difunctional isocyanate such as xylene diisocyanate; a compound prepared by introducing a high molecular compound such as polyether having an active hydrogen such as polyethylene oxide into an adduct of a polyol such as trimethylol propane and a difunctional isocyanate such as xylene diisocyanate; and a formalin condensate of benzene isocyanate.

Other preferred examples include compounds disclosed in JP-A Nos. 62-212190, 4-26189 and 5-317694, and Japanese Patent Application No. 8-268721, the disclosures of which are incorporated by reference herein.

The isophorone diisocyanate compound is preferably added such that the average particle diameter of the microcapsules is from 0.3 to 12 um and the thickness of the capsule walls is from 0.01 to 0.3 um. The size of the dispersed particle is generally from about 0.2 to 10 um.

Specific examples of the polyol and/or the polyamine, which is added to the water phase and/or the oil phase as one of the components that react with a polyisocyanate to form a microcapsule wall, include propylene glycol, glycerin, trimethylolpropane, triethanloamine, sorbitol, and hexamethylenediamine. When a polyol is added thereto, polyurethane walls are formed. In the above-mentioned reaction, it is preferable to keep the reaction temperature high or add an appropriate polymerization catalyst in order to increase the reaction velocity.

The polyisocyanate, the polyol, the reaction catalyst, the polyamine for forming a part of capsule walls, and the like are described in detail in Polyurethane Handbook, edited by Keiji Iwata and published by the Nikkan Kogyo Shimbun, Ltd. (1987), the disclosure of which is incorporated by reference herein.

If necessary, a charge adjusting agent such as a metal-containing dye or nigrosin, or any other additive may be added to the microcapsule walls. These additives can be added at the time of forming the walls, or at any other time, to be incorporated in the walls of the capsules. If necessary, a monomer such as a vinyl monomer may be graft-polymerized in order to adjust the charging property of the surfaces of the capsule walls.

In order to make microcapsule walls having excellent substance-permeability and color-formability even at a lower temperature, it is preferable to use a plasticizer suitable for the polymer used as the wall material. The plasticizer preferably has a melting point from about 50° C. to about 120° C. It is particularly preferable to select a plasticizer which has such a melting point and takes a solid form at ordinary temperature.

For example, when the wall material is polyurea or polyurethane, it is preferable to use a hydroxy compound, a carbamic acid ester compound, an aromatic alkoxy compound, an organic sulfonamide compound, an aliphatic amide compound, an arylamide compound or the like, as a plasticizer.

When the oil phase is prepared, it is preferable to use an organic solvent having a boiling point of from 100 to about 300° C. as a hydrophobic organic solvent in which the basic dye precursor or the photolytic diazo compound is dissolved for forming cores of microcapsules.

Specific examples thereof include esters, dimethylnaphthalene, diethylnaphthalene, diisopropylnaphthalene, dimethylbiphenyl, diisopropylbiphenyl, diisobutylbiphenyl, 1-methyl-1-dimethylphenyl-2-phenylmethane, 1-ethyl-1-dimethylphenyl-1-phenylmethane, 1-propyl-1-dimethylphenyl-1-phenylmethane, triallylmethane (such as tritoluoylmethane and toluoyldiphenylmethane), terphenyl compounds (such as terphenyl), alkyl compounds, alkylated diphenyl ether compounds (such as propyldiphenyl ether), hydrogenated terphenyl compounds (such as hexahydroterphenyl), and diphenyl ether. Among these examples, esters are particularly preferable from the viewpoints of the emulsification stability of the emulsion.

Examples of the esters include phosphate esters such as triphenyl phosphate, tricresyl phosphate, butyl phosphate, octyl phosphate and cresylphenyl phosphate; phthalic esters such as dibutyl phthalate, 2-ethylhexyl phthalate, ethyl phthalate, octyl phthalate, and butylbenzyl phthalate; dioctyl tetrahydrophthalate; benzoic esters such as ethyl benzoate, propyl benzoate, butyl benzoate, isopentyl benzoate, and benzyl benzoate; abietic esters such as ethyl abietate, and benzyl abietate; dioctyl adipate; isodecyl succinate; diocyl azelate; oxalic esters such as dibutyl oxalate and dipentyl oxalate; diethyl malonate; maleic esters such as dimethyl maleate, diethyl maleate, and dibutyl maleate; tributyl citrate; sorbic esters such as methyl sorbate, ethyl sorbate and butyl sorbate; sebacic esters such as dibutyl sebacate, and dioctyl sebacate; ethylene glycol esters such as formic monoester and diester, butyric monoester and diester, lauric monoester and diester, palmitic monoester and diester, stearic monoester and diester, and oleic monoester and diester; triacetin; diethyl carbonate; diphenyl carbonate; ethylene carbonate; propylene carbonate; boric esters such as tributyl borate and tripentyl borate.

Among them, it is preferable to use, as the organic solvent, tricresyl phosphate alone or in combination with other solvent(s) since the stability of the emulsion becomes most satisfactory. The above-mentioned oils may be used in any combination thereof, or the oil(s) may be used together with an oil other than the above-mentioned oils.

If the solubility of the basic dye precursor, which is to be encapsulated, in the hydrophobic organic solvent is low, a low boiling point solvent in which the basic dye precursor dissolves well may be used simultaneously as an auxiliary solvent. Preferable examples of the low boiling point solvent include ethyl acetate, isopropyl acetate, butyl acetate and methylene chloride.

In order to obtain a high mark density with a small coating composition amount, as described in JP-A No. 4-101885, only a low boiling point solvent may be used as a solvent for forming microcapsules. In this case, the above-mentioned low boiling point solvent as an auxiliary solvent may be suitably used.

When the basic dye precursor compound is included in the recording layer of the recording material, the content of the basic dye precursor is preferably from 0.1 to 5.0 g/m2, more preferably from 1.0 to 4.0 g/m².

When the content of the basic dye precursor is within the above-mentioned range, a sufficient color density can be obtained. When the content of the basic dye precursor compound is 5.0 g/m2 or less, a sufficient color density can be obtained and the transparency of the recording layer can be maintained.

The water phase may be an aqueous solution comprising a dissolved water-soluble polymer as a protective colloid. The above-mentioned oil phase is added to the water phase, and then the mixture is emulsified with a homogenizer or the like. The water-soluble polymer acts as a dispersing medium for achieving homogeneous dispersion easily and stabilizing the emulsified solution. A surfactant may be added to at least one of the oil phase and the water phase in order to achieve more homogenous and stable dispersion. As the surfactant, a well-known surfactant for emulsification can be used. The amount of the surfactant to be added is preferably from 0.1 to 5%, more preferably from 0.5 to 2% by mass of the amount of the oil phase.

As the surfactant added to the water phase, a surfactant which does not cause precipitation or aggregation caused by a reaction with the protective colloid is appropriately selected from anionic and nonionic surfactants.

Preferable examples of the surfactant include sodium alkylbenzenesulfonate, sodium alkylsulfate, sodium dioctyl sulfosuccinate, polyalkylene glycol (such as polyoxyethylene nonyl phenyl ether), acetylene glycol and the like.

The oil phase containing the above-mentioned components and the water phase containing the protective colloid and the surfactant can be emulsified by a known ordinary means for emulsifying fine particles, such as high-speed stirring means or ultrasonic wave dispersing means. Specific examples of the means include a homogenizer, a Manton-Gaulin, an ultrasonic wave disperser, a dissolver, or a Kdmill. In order to promote the reaction for forming capsule walls after the emulsification, it is preferable to heat the emulsion to a temperature of from about 30° C. to about 70° C. In order to prevent the aggregation between the capsules during the reaction, it is preferable to add water to the reaction system so as to lower the probability of collision between the capsules, or perform stirring sufficiently.

During the capsule forming reaction, a dispersion agent for preventing aggregation may be newly added. With the advance of the polymerization reaction, generation of carbon dioxide is observed. The termination of the generation can be regarded as the end point of the capsule wall forming reaction. Usually, target microcapsules can be obtained by several hours reaction.

### (Emulsion)

If the basic dye precursor is used as core materials to form microcapsules, the coupler compound can be solid-dispersed together with, for example, a water-soluble polymer, an organic base, and other color-forming auxiliary/auxiliaries, by means of a sand mill or the like before use. However, it is preferable to dissolve the coupler in a high boiling point organic solvent which is scarcely soluble or insoluble in water, then mix this solution with an aqueous polymer solution (water phase) containing, as a protective colloid, a surfactant and/or a water-soluble polymer, then emulsify the resultant mixture by means of a homogenizer or the like, then use the resulting emulsion. In this case, a low boiling point solvent may be used as a dissolving auxiliary if necessary.

The coupler and the organic base may be separately emulsified or may be mixed with each other, dissolved into a high boiling point organic solvent and emulsified. The size of the emulsified particle is preferably 1 um or less.

The high boiling point organic solvent used in this case can be appropriately selected from the high boiling point oils described in JP-A No. 2-141279, the disclosure of which is incorporated by reference herein.

Among the oils, it is preferable to use esters from the viewpoint of the emulsification stability of the resultant emulsion. Among the esters, tricresyl phosphate is particularly preferable. The above oils may be used in any combination thereof, or the oil(s) may be used simultaneously with an oil other than the above oils.

The water-soluble polymer contained as the protective colloid can be appropriately selected from known anionic polymers, nonionic polymers and amphoteric polymers. The water-soluble polymer has a solubility in water of preferably 5% or more at a temperature at which the emulsification is conducted. Specific examples of the water-soluble polymer include: polyvinyl alcohol and modified products thereof, polyacrylic amide and derivatives thereof, ethylene-vinyl acetate copolymer; styrene-maleic anhydride copolymer; ethylene-maleic anhydride copolymer; isobutylene-maleic anhydride copolymer; polyvinyl pyrrolidone; ethylene-acrylic acid copolymer; vinyl acetate-acrylic acid copolymer; cellulose derivatives such as carboxymethylcellulose and methylcellulose; casein; gelatin; starch derivatives; gum arabic; and sodium alginate.

Among these polymers, polyvinyl alcohol derivatives are more preferable, and polyvinyl alcohol contained carboxy substitute is particularly preferable for stabilizing viscosity of the coating composition.

The mixing ratio of the oil phase to the water phase (the mass of the oil phase/the mass of the water phase) is preferably from 0.02 to 0.6, more preferably from 0.1 to 0.4. When the mixing ratio is within the range of 0.02 to 0.6, the liquid coating composition has an appropriate viscosity, thus the production of the recording material is easier, and the stability of the liquid coating composition with time is superior.

When the electron-accepting compound is included in the coating composition that is used in the invention, the amount of the electron-accepting compound is preferably from 0.5 to 30 parts by mass, more preferably from 1.0 to 10 parts by mass based on 1 part by mass of the basic dye precursor.

### (Chemical Coating Composition for Forming Recording Layer)

The coating composition for forming the recording layer can be prepared, for example, by mixing the microcapsule solution and the emulsion prepared as described above. The water-soluble polymer used as a protective colloid during the preparation of the microcapsule solution and the water-soluble polymer used as a protective colloid during the preparation of the emulsion function as binders in the recording layer. A binder other than these protective colloids may preferably be further added during the preparation of the coating composition for forming the recording layer.

Examples of the binder contained in the coating composition include polyvinyl alcohol derivatives, hydroxyethylcellulose, hydroxypropylcellulose, epichlorohydrin-modified polyamide, ethylene-maleic anhydride copolymer, styrene-maleic anhydride copolymer, isobutylene-maleic anhydride-salicylic acid copolymer, polyacrylic acid, polyacrylic amide, methylol-modified polyacrylamide, starch derivatives, casein, and gelatin.

Among these polymers, polyvinyl alcohol derivatives are more preferable, and polyvinyl alcohol containing carboxy substituents is particularly preferable for stabilizing viscosity of the coating composition.

For the binder, any water-resistance imparting agent may be added in order to provide water resistance, and/or an emulsion of a hydrophobic polymer. Specific examples of these include styrene-butadiene rubber latex and acrylic resin emulsion, may be added.

When the coating composition for forming the recording layer is applied to a support, a known application means used for water-based or organic solvent-based coating composition is used. In this case, in order to apply the coating composition for forming the recording layer safely and uniformly and assure the strength of the coating, at least one chemical is selected from the following which can be included in the coating composition for the recording material that is used in the invention: methylcellulose, carboxymethylcellulose, hydroxyethylcellulose, starch, gelatin, polyvinyl alcohol, polyacrylamide, polystyrene or copolymers thereof, polyester or copolymers thereof, polyethylene or copolymers thereof, epoxy resin, acrylate resin or copolymers thereof, methacrylate resin or copolymers thereof, polyurethane resin, polyamide resin, polyvinyl butyral resin, styrene-butadiene latex, and the like.

Among these polymers, polyvinyl alcohol derivatives are more preferable, and polyvinyl alcohol contained carboxy substituents is particularly preferable for stabilizing the viscosity of the coating composition.

### (Other Components)

Other components that can be used in the coating composition will be described hereinafter.

Such other components can be appropriately selected, without particular limitation, in accordance with the specific purpose of the coating. Examples thereof include additives known in the art, such as a thermally-meltable material, an ultraviolet absorber, and an antioxidant.

The amount of each of such other components to be applied is preferably from about 0.05 to 1.0 g/m², more preferably from about 0.1 to 0.4 g/m². Such components may be included in the inside and/or on the outside of the microcapsules.

The thermally-meltable material can be included in the recording layer in order to improve the thermal responsiveness thereof.

Examples of the thermally-meltable material include am aromatic ether, a thioether, an ester, an aliphatic amide and an ureido. As examples, these compounds are described in JP-A Nos. 58-57989, 58-87094, 61-58789, 62-109681, 62-132674, 63-151478, 63-235961, 2-184489 and 2-215585, the disclosures of which are incorporated by reference herein.

Preferable examples of the ultraviolet ray absorber include benzophenone ultraviolet ray absorbers, benzotriazole ultraviolet ray absorbers, salicylic acid ultraviolet ray absorbers, cyanoacrylate ultraviolet ray absorbers, and oxalic acid anilide ultraviolet ray absorbers. Examples thereof are described in JP-A Nos. 47-10537, 58-111942, 58-212844, 59-19945, 59-46646, 59-109055 and 63-53544, Japanese Patent Application Publication (JP-B) Nos. 36-10466, 42-26187, 48-30492, 48-31255, 48-41572, 48-54965 and 50-10726, and U.S. Pat. Nos. 2,719,086, 3,707,375, 3,754,919 and 4,220,711, the disclosures of which are incorporated by reference herein.

Examples of the antioxidant include hindered amine antioxidants, hindered phenol antioxidants, aniline antioxidants, and quinoline antioxidants. Antioxidants thereof are described in, for example, JP-A Nos. 59-155090, 60-107383, 60-107384, 61-137770, 61-139481 and 61-160287, the disclosures of which are incorporated by reference herein.

It is preferable that the recording layer is applied such that a solid application amount thereof after application and drying will be from 0.5 to 25 g/m² and the thickness of the recording layer will be 0.5 to 25 um. A plurality of such recording layers may be provided. In this case, the solid application amount of all the recording layers is preferably from 0.5 to 25 g/m.

### <Protective Layer>

The recording material can have a protective layer as an uppermost layer at the recording layer side of the material. Usually, the protective layer is formed by applying a liquid chemical coating composition for the protective layer. Such a composition is described in, for example, JP-A 2007-152686A.

However the recording material that is used in the invention has preferably no protective layer applied on the recording layer. The present invention is based on the new finding that the removal of a protective layer on the recording layer can significantly increase optical density of the mark formed by the laser irradiation.

### <Support>

Usually, any kind of support can be used. These are described in, for example JP-A 2007-152686A.

However the recording material that is used in the invention has preferably the support of a corrugated fiberboard for outer case. Embodiments of the present invention are based on the new finding that the support of a corrugated fiberboard for outer case can increase lay-down of the chemical coating composition and increase the optical density of the mark formed by the laser irradiation.

### <Other Layers>

In embodiments of the present invention, at any position on the support, for the purpose of preventing fading of the image, an ultraviolet ray filter layer may be provided. The ultraviolet ray filter layer contains an ultraviolet ray absorber compound such as benzotriazole compounds, benzophenone compounds, and hindered amine compounds.

Further, an antireflection layer may be provided. The antireflection layer can be formed by a mixture containing particles that are usable in the back layer as a preferable matting agent.

In order to prevent the peeling of the recording layer from the support, an undercoat layer may be provided on the support before the recording layer and the like are provided on the support.

The undercoat layer may comprise at least one compound selected from acrylic ester copolymers, polyvinylidene chloride, SBR, aqueous polyesters and the like. The thickness thereof is preferably from 0.05 to 0.5 um.

When the recording layer is applied on the undercoat layer, the undercoat layer may swell by water contained in the coating composition solution for forming the recording layer so that the image recorded in the recording layer may deteriorate. It is therefore preferable to use a hardening agent such as a dialdehyde (such as glutaraldehyde or 2,3-dihydroxy-1,4-dioxane) or boric acid to harden the layer. The amount of the hardening agent to be added may be appropriately determined within the range of 0.2 to 3.0% by mass based on the dry mass of the undercoat layer in accordance with a desired hardness.

The recording material used in embodiments of the invention may be manufactured, for example, in the following procedure, but the method is not limited thereto. At one side of a support, a liquid coating composition for forming a recording layer (hereinafter referred to as a “recording layer coating liquid”) is applied to form a recording layer using flexo printing machine, gravure printing machine, off set printing machine, roller coating machine, curtain coating machine, and other coating methods. It is preferably applied onto the support as an ink using flexo printing machine, gravure printing machine.

The recording method of the invention is a method of recording an image on the above-mentioned recording material by irradiating a laser. The laser preferably has a wavelength of 1 to 11 um. The wavelength of the CO2 laser to be irradiated is preferably 9 to 11 um, more preferably 9.2 to 10.6 um. By irradiating a CO2 laser having a wavelength of 9 to 11 um, an image of high printing density can be recorded.

The CO2 laser is not particularly limited, as far as a CO2 laser light having a wavelength of 9 to 11 um can be irradiated, and may be properly selected depending on the purpose, and a commercial laser can be used. Examples include BLAZAR 6000 manufactured by LaserTechnics, Inc., Unimark manufactured by Ushio Inc., Zymark 7000 manufactured by Coherent, Inc., ML-9110 manufactured by Keyence, Smart Rays 110 manufactured by EDM CORP., and Domino Scanning Laser manufactured by Comes Dodwell.

The CO2 laser is preferably irradiated while adjusting such that the energy on the recording material surface is 10 to 200 mJ/mm². More preferably, the energy on the recording material surface is 10 to 150 mJ/mm<2>. If the energy by the CO2 laser is less than 10 mJ/mm², sufficient color-forming may not be achieved, or if exceeding 200 mJ/mm², ablation may occur and the colored recording layer may be lost.

### EXAMPLES

Embodiments of the invention is specifically described below by presenting examples, but the invention is not limited to these examples alone. In the example, the unit “%” refers to “% by mass” unless otherwise specified.

### Example-1

### Preparation of Liquid Coating Composition Containing Microcapsules

6.0 g of 2-anilino-6-(N-ethyl-N-isobutylamino)-3-methylfluoran and 1.0 g of 2-(2-hydroxy-5-methylpheyl)benzotriazole were added to 16.0 g of ethyl acetate, heated to about 70° C. and dissolved, and cooled to 45° C. To this, 10.0 g of capsule wall material (Takenate D140N, manufactured by Takeda Pharmaceutical Co., Ltd.) was added and mixed. This solution was added to the water phase of 47.7 g of 5% polyvinyl alcohol with carboxylic substitute (OTP-5, manufactured by Kuraray), and emulsified and dispersed for 5 minutes at 15,000 rpm by using an Ace Homogenizer (manufactured by Nippon Seiki Co., Ltd.). An encapsulating reaction was conducted for 4 hours at 60° C., whereby a liquid coating composition containing microcapsules having an average particle diameter of 0.8 um was prepared.

### <Preparation of Recording Layer Liquid Coating Composition>

A recording layer liquid coating composition was prepared by mixing 30.0 g of the liquid coating composition containing microcapsules, 60 g of electron accepting compound (USR-054, manufactured by SANKO Co. Ltd./solid content concentration: 42.5%), 4.0 g of 20% polyvinyl alcohol (Mowiol 4-88, manufactured by Kuraray), 4.0 g of colloidal silica (Snowtecs, manufactured by Nissan Chemical Industries, Ltd.), 0.5 g of Surfynol 104 PG50 (manufactured by AIR PRODUCTS), polyurethane compound (W835-140, manufactured by Incorez), and 5.0 g of dispersion of combination of polyethylene wax and polytetrafluoroethylene (Microspersion 190-50, manufactured by MICRO POWDERS, Inc.).

### <Preparation of Recording Layer>

On one side of white semi-gloss paper label (manufactured by Fasson) having a thickness of 0.16 mm, the recording layer liquid coating composition was applied by Phantom Hand Proofer (manufactured by Harper Scientific) that is flexographic-type proofing systems incorporated ceramic anilox roller (anilox roller cell volume is 10 BCM), steel doctor blades and solvent resistant rubber rolls., and then dried, whereby a recording layer was formed on the support. At this time, the liquid coating composition temperature of each layer was adjusted in a range of 23° C. to 27° C. The coating speed was 100 feet/min, the support was subsequently air-dried at a temperature of 45° C. to 55° C.

### Example-2

### Preparation of Liquid Coating Composition Containing Microcapsules

Is prepared as the same as in Example-1.

### <Preparation of Recording Layer Liquid Coating Composition>

Is prepared as the same as in Example-1.

### <Preparation of Recording Layer>

On one side of a white corrugated fiberboard support (manufactured by Rock Term) having a thickness of 3 mm, the recording layer liquid coating composition is applied by a Phantom Hand Proofer (manufactured by Harper Scientific) that is a flexographic-type proofing systems incorporating a ceramic anilox roller (anilox roller cell volume is 10 BCM), steel doctor blades, and solvent resistant rubber rolls, and then dried, whereby a recording layer was formed on the support. At this time, the temperature of each layer of the liquid coating composition was adjusted in a range of 23° C. to 27° C. The coating speed was 100 feet/min, and the support was subsequently air-dried at a temperature of 45° C. to 55° C.

### Comparative Example-1

### Preparation of Liquid Chemical Coating Composition Containing Microcapsules

Is prepared as the same as in Example-1.

### <Preparation of Recording Layer Liquid Chemical Coating Composition>

Is prepared as the same as in Example-1 except that the inventive dispersion of a combination of polyethylene wax and polytetrafluoroethylene (Microspersion 190-50, manufactured by MICRO POWDERS, Inc.) is not incorporated.

### <Preparation of Recording Layer>

On one side of white semi-gloss paper label (manufactured by Fasson) having a thickness of 0.16 mm, the recording layer liquid coating composition was applied by a Phantom Hand Proofer (manufactured by Harper Scientific) that is a flexographic-type proofing systems which incorporates ceramic anilox rollers (anilox roller cell volume is 10 BCM), steel doctor blades, and solvent-resistant rubber rollers, and then dried, whereby a recording layer was formed on the support. At this time, the liquid coating composition liquid temperature of each layer was adjusted in a range of 23° C. to 27° C. The coating speed was 100 feet/min, and the support was subsequently air dried at a temperature of 45° C. to 55° C.

After drying, a water-based protective coat liquid of CK-43P-23L (manufactured by Cork Industries) was applied by the use of a Phantom Hand Proofer (manufactured by Harper Scientific) that is a flexographic-type proofing system which incorporates ceramic anilox roller (anilox roller cell volume is 8 BCM), steel doctor blades, and solvent-resistant rubber rollers, and then dried, whereby a recording layer was formed on the support. At this time, the liquid coating composition temperature of each layer was adjusted in a range of 23° C. to 27° C. The coating speed was 100 feet/min, and the support was subsequently air-dried at a temperature of 45° C. to 55° C.

### Comparative Example-2

### Preparation of Liquid Coating Composition Containing Microcapsules

Is prepared as the same as in Example-1.

### <Preparation of Recording Layer Liquid Coating Composition>

Is prepared as the same as Example-1 except that the inventive dispersion of a combination of polyethylene wax and polytetrafluoroethylene (Microspersion 190-50, manufactured by MICRO POWDERS, Inc.) is not incorporated.

### <Preparation of Recording Layer>

On one side of a white semi-gloss paper label (manufactured by Fasson) having a thickness of 0.16 mm, the recording layer liquid chemical coating composition was applied by Phantom Hand Proofer (manufactured by Harper Scientific) that is a flexographic-type proofing systems incorporating ceramic anilox roller (anilox roller cell volume is 10 BCM), steel doctor blades, and solvent resistant rubber rolls, and then dried, whereby a recording layer was formed on the support. At this time, the coating liquid temperature of each layer was adjusted in a range of 23° C. to 27° C. The coating speed was 100 feet/min, and the support was subsequently air dried at a temperature of 45° C. to 55° C.

### Evaluation-1 (Laser Marking Density)

In comparative examples 1 and 2, in which marking was carried out by a carbon dioxide (CO²) laser (Video Jet 3120 10W CO2 Laser/intensity 50%, speed 7000 mm/sec), the optical density of the laser marking area was measured. Results are shown in Table 1.

### Evaluation-2 (Pressure Marking Density by Scratching)

In Examples 1 and 2, and Comparative Example 1 and 2 in which scratching was carried out by a scratching test equipment of Taber Linear Abraser model 5750 (manufactured by Taber Industries/weight 500 g, Tip No. EURO 84130 (1 mm diameter), speed 4 inch/min), the optical density of the scratching area was measured. Results are shown in Table 1.

### Evaluation-3 (Viscosity Stability of Recording Layer Coating Liquid)

Viscosity of the recording layer coating liquids in example 1 and 2, and comparative example 1 and 2 were measured before and after storage under the temperature at 50° C. for 2 weeks by Zahn Cup No. 2. Results are shown in Table 1.

TABLE 1

| | Comparative- | Comparative- | | |
|---|---|---|---|---|
| | Example 1 | Example 2 | Example-1 | Example-2 |
| Wax Dispersion | Not included | Not included | Included | Included |
| of PE/PTFE | | | | |
| Support | Paper Label | Paper Label | Corrugated | Corrugated |
| | | | fiberboard | fiberboard |
| Protective layer | Applied | Not applied | Not applied | Not applied |
| note | Comparative | Comparative | Invention | Invention |
| Density of laser | 0.62 | 0.61 | 1.10 | 1.44 |
| marking | | | | |
| Density of | 0.03 | 0.49 | 0.03 | 0.00 |
| scratching | | | | |
| Viscosity | 25 sec | 25 sec | 25 sec | 25 sec |
| before storage | | | | |
| Viscosity after | 42 sec | 42 sec | 25 sec | 25 sec |
| storage | | | | |

As is clear from Table 1, the laser marking density is high, the scratching density is very low, and viscosity stability is excellent in Examples 1 and 2. In one embodiment of the present invention, a corrugated fiberboard support is preferable.

We claim:

1. A chemical coating composition for a recording material to record an image by irradiation of a laser beam, comprising at least one microcapsule encapsulating a basic dye precursor, and at least one plastic dispersion.

2. A chemical coating composition according to claim 1, wherein the plastic dispersion comprises at least one plastic wax dispersion.

3. A chemical coating composition according to claim 1, wherein the plastic dispersion comprises at least one polyethylene wax dispersion.

4. A chemical coating composition according to claim 1, wherein the plastic dispersion comprises at least one dispersion of a combination of a polyethylene wax and polytetrafluoroethylene.

5. A chemical coating composition according to claim 1, comprising at least one polyvinyl alcohol containing a carboxylic substituent.

6. A recording material and the recording method to record an image by irradiation of a laser beam, comprising a recording layer on a support, wherein the recording layer comprises a microcapsules encapsulating at least one basic dye precursor, and at least one plastic dispersion.

7. A recording material and the recording method according to claim 6, wherein the recording layer comprises at least one chemical coating composition according to claim 1.

8. The recording material and the recording method according to claim 6 in which the recording material has no protective layer on the recording layer.

9. The recording material and the recording method according to claim 6, wherein the support comprises a corrugated fiberboard.
